(19) United States
(12) Patent Application Publication
(10) Pub. No.: US 2005/0100341 A1
(43) Pub. Date: May 12, 2005

(54) Optical transmission apparatus and electronic equipment provided with same

(76) Inventors: Kazuhito Nagura, Kashihara-shi (JP); Motoki Sone, Kitakatsuragi-gun (JP)

Correspondence Address: BIRCH STEWART KOLASCH & BIRCH, PO BOX 747, FALLS CHURCH, VA, 22040-0747, US

(21) Appl. No.: 10/655,222

(22) Filed: Sep. 5, 2003

(30) Foreign Application Priority Data
Sep. 6, 2002 (JP) 2002-261696
Jul. 4, 2003 (JP) 2003-192064

(51) Int. Cl. H04B 10/00

(52) U.S. Cl. 398/140

(57) ABSTRACT

Terminal(s) 15 may transmit optical signal(s) representing video data conforming to DV-format signal transmission protocol(s) to optical transmission apparatus(es) 11 by way of optical fiber(s) 14. At optical transmission apparatus(es) 11, such optical signal(s) may be converted into electrical signal(s) by optical transceiver(s) 22, and such electrical signal(s) may be converted into signal(s) conforming to specifications of state machine(s) 16 and may be output. Microcomputer(s) 17 and link interface(s) 18 may be connected to state machine(s) 16 and may provide application protocol conversion functionality or functionalities 24 thereto. Such functionality or functionalities may allow the foregoing signal(s) to be converted into signal(s) representing MPEG-2TS-format video data, and such signal(s) produced as a result of conversion may be output to DS port(s) 19. DS port(s) 19 may transmit both signals or sets of signals to external terminal(s) 13 by way of conductive connector(s) 21 and conductive cable(s) 12. Furthermore, microcomputer(s) 17 may be provided with bus management functionality or functionalities 23 for managing bus(es) comprising conductive cable(s) 12 and optical fiber(s) 14.

### TECHNICAL FIELD

The present invention pertains to an optical transmission apparatus capable of transmitting and/or receiving as it carries out mutual conversion between or among optical signals and electrical signals such as are, for example, employed at IEEE 1394 (Institute of Electrical and Electronics Engineers 1394) and pertains to electronic equipment provided with same.

### BACKGROUND ART

Conventional apparatuses which transmit and receive optical signals include the “optical repeater” disclosed at Japanese Patent Application Publication Kokai No. S60-153651 (1985) (pages 2 through 3, FIG. 2). As shown in FIG. 3, at this optical repeater 100, an optical signal transmitted thereto by way of downlink optical fiber 101 is converted into an electrical signal by high-speed optical-to-electrical converter circuit 102, this electrical signal is demodulated by demodulator circuit 103, forming an NRZ signal, this NRZ (nonreturn-to-zero) signal is modulated by resynchronizing modulator circuit 104, forming a resynchronized electrical signal, this electrical signal is converted into an optical signal by high-speed electrical-to-optical converter circuit 105, and this optical signal is sent by way of downlink optical fiber 101. Furthermore, the NRZ signal is converted to an optical signal by low-speed electrical-to-optical converter circuit 106, and this optical signal is sent by way of optical fiber 107. In similar fashion, high-speed optical-to-electrical converter circuit 112, demodulator circuit 113, resynchronizing modulator circuit 114, and high-speed electrical-to-optical converter circuit 115 are likewise inserted at uplink optical fiber 111. Furthermore, an optical signal transmitted thereto by way of optical fiber 116 is converted into an NRZ signal by low-speed optical-to-electrical converter circuit 117, and this NRZ signal is input to resynchronizing modulator circuit 114 by way of logical OR circuit 118.

Furthermore, at Japanese Patent Application Publication Kokai No. H12-224256 (2000) (pages 3 through 5, FIG. 2), an “optical transmission apparatus” is disclosed. As shown in FIG. 4, at this apparatus 200, interfaces L1 through L6 carrying out signal transmission in accordance with mutually different respective protocols are connected to connector 201, any of interfaces L1 through L6 is or are selected by means of selector 202 and is or are connected to code converter 203; and moreover, optical transmitter 204 transmitting optical signals and optical receiver 205 receiving optical signals are connected to code converter 203, transmit data from said selected interface(s) being transmitted by way of code converter 203 and optical transmitter 204, and receive data being transferred to said selected interface(s) by way of optical receiver 205 and code converter 203. Code converter 203 “absorbs” differences among protocols at interfaces L1 through L6, code conversion being carried out on receive data for any of the interface(s) in correspondence to the protocol(s) at the interface(s).

Moreover, as shown in FIG. 5, provided at known IEEE-1394-compliant apparatus 300 are physical layer (made up LSIs and so forth) 305 as defined at IEEE 1394 and comprising IEEE-1394b-compliant state machine 301, link interface 302, DS port 303, and optical port 304; electrical connector 306; and optical transceiver 307; DS (Data-Strobe) signals being transmitted and received at DS port 303 by way of electrical connector 306, and optical signals being transmitted and received at optical port 304 by way of optical transceiver 307; DS signals being converted to optical signals before being transferred, and optical signals being converted to DS signals before being transferred, to carry out repeater operations.

However, the apparatus of FIG. 3 does nothing more than act as repeater for optical signals, neither protocol conversion at the physical-layer level nor protocol conversion at the application level being carried out.

Furthermore, the apparatus of FIG. 4 is for “absorbing” differences among protocols at interfaces L1 through L6, and while protocol conversion is carried out at the physical-layer level, protocol conversion is not carried out at the application level.

Moreover, while the apparatus of FIG. 5 does carry out mutual conversion between electrical signals and optical signals; i.e., carrying out protocol conversion at the physical-layer level, protocol conversion is not carried out at the application level.

Where protocol conversion is, as is the case here, not carried out at the application level, the effort that goes into transmission and/or repeating of data may not produce corresponding effect. For example, where video data is received from a transmitting terminal (e.g., a DVC) on which there are installed only DV-format (Digital Video) applications and this video data is transferred to a receiving terminal (e.g., a digital TV) on which there are installed only MPEG-2TS-format applications, it will not be possible to play the video at the receiving terminal.

Moreover, even if protocol conversion were to be carried out at the application level, so long as bus management is not carried out, data transfer will prove difficult. For example, with the apparatus at FIG. 5, because state machine 301 complies with IEEE 1394b and the repeat delay could exceed the 144 ns defined at IEEE 1394-1995, it will be necessary to carry out bus management according to PING (Packet InterNet Groper) or other such protocol which sets parameters for determining bus arbitration time based on actual measurement of packet transmission time. If data transfer is carried out to/from a terminal which neither possesses such bus management functionality nor complies with IEEE 1394, then bus communications will be disrupted when the transmission delay of the data on the bus exceeds 144 ns, preventing transmission and/or receipt of video data or the like to/from the terminal.

Because the apparatuses at FIGS. 3, 4, and 5 not only do not carry out protocol conversion at the application level but also do not carry out bus management, in the event that the protocols at the application level are mutually different between or among external terminals, accommodation of data transfer between or among said external terminals will be utterly impossible.

Furthermore, the apparatus at FIG. 5 employs a twin-core optical cable to carry out optical transmission, and the optical connector at optical transceiver 307 is large. Because of its size, this connector is ill-suited for video equipment, audio equipment, personal computers, and other such ordinary households terminals, an electrical connector (metal i.LINK) being used for connection to ordinary households terminals. This therefore does not represent a solution that would overcome the disadvantage of having to use an electrical connector even for devices such as audio equipment for which it is desired that adequate electrical isolation be achieved in order to prevent degradation in sound quality.

The present invention was therefore conceived in light of the foregoing conventional problems, it being an object thereof to provide an optical transmission apparatus capable of carrying out bus management and/or protocol conversion at the application level, as well as electronic equipment provided with same.

### SUMMARY OF INVENTION

In order to solve the foregoing and/or other problems, an optical transmission apparatus in accordance with one or more embodiments of the present invention may have a plurality of ports for transmitting and/or receiving one or more signals substantially as defined at IEEE 1394; at least one of the ports being for transmitting and/or receiving one or more optical signals; and signal transmission protocol conversion being carried out at the physical-layer level on at least one of the signals transmitted and/or received by at least one of the ports; wherein the optical transmission apparatus comprises one or more bus management means for co-managing one or more signal buses respectively connected externally to at least a portion of the ports.

In accordance with embodiment(s) constituted in such fashion, as respective signals as defined at IEEE 1394 are transmitted and/or received by way of ports, signal transmission protocol conversion may be carried out at the physical-layer level, and moreover, bus management whereby respective signal buses externally connected to ports are co-managed may be carried out. This being the case, signal transmission protocol conversion may be carried out at the physical-layer level between or among DS signal(s) and optical signal(s); e.g., with DS signal(s) being transmitted to and/or received from external terminal(s) by way of DS signal bus(es) and/or optical signal(s) being transmitted to and/or received from other external terminal(s) by way of optical signal bus(es), permitting accommodation of data transfer between or among said respective external terminals without tending to cause failure of bus communications.

Furthermore, one or more embodiments of the present invention may further comprise one or more application-level protocol conversion means for carrying out signal transmission protocol conversion at the application level.

By carrying out signal transmission protocol conversion at the application level in such fashion, it is possible to accommodate, as data transfer between or among respective external terminals, transfer of data for mutually different respective applications between or among said terminals.

At the foregoing constitution(s), the constitution may be such that at least one of the application-level protocol conversion means carries out conversion between or among one or more DV-format signal transmission protocols and one or more MPEG-2TS-format signal transmission protocols. In such a case, where video data is received from transmitting terminal(s) (e.g., DVC(s)) on which there are installed only DV-format application(s) and this video data is converted from DV format to MPEG-2TS format before this video data is transferred to receiving terminal(s) (e.g., digital TV(s)) on which there are installed only MPEG-2TS-format application(s), it will be possible to play the video at the receiving terminal(s). And of course it will also be possible to receive MPEG-2TS-format video data and convert this video data to DV-format video data before transferring same.

Alternatively or in addition thereto, the constitution may be such that at least one of the application-level protocol conversion means carries out conversion between or among one or more 1-bit audio signal transmission protocols and one or more multi-bit audio signal transmission protocols. In such a case, where 1-bit audio signal(s) are received from transmitting terminal(s) on which there are installed only 1-bit audio application(s) and such audio signal(s) are converted to multi-bit audio signal(s) before such audio signal(s) are transferred to receiving terminal(s) on which there are installed only multi-bit audio application(s), it will be possible to play the audio at the receiving terminal(s). And of course it will also be possible to receive multi-bit audio signal(s) and convert such audio signal(s) to 1-bit audio signal(s) before transferring same.

At such constitution(s), at least one of the multi-bit audio signal transmission protocol or protocols may be substantially as defined at IEC 60958. Alternatively or in addition thereto, at least one of the multi-bit audio signal transmission protocol or protocols may be substantially as defined at MPEG Audio Layer-3.

Furthermore, in one or more embodiments of the present invention, one or more of the application-level protocol conversion means may take the form of one or more replaceable modules.

When constituted in such fashion, replacement of such module(s) will make it possible to accommodate, as application-level signal transmission protocol conversion(s), a great many types of protocol conversion.

Furthermore, electronic equipment in accordance with one or more embodiments of the present invention may comprise one or more optical transmission apparatuses according to any of the foregoing embodiments of the present invention.

Examples of such electronic equipment include various types of video equipment, audio equipment, personal computers, and so forth.

Such electronic equipment in accordance with one or more embodiments of the present invention may permit achievement of operation and effect similar to that which is provided by optical transmission apparatuses in accordance with the foregoing embodiments of the present invention.

### BRIEF DESCRIPTION OF DRAWINGS

FIG. 1 is a block diagram showing an embodiment of the optical transmission apparatus of the present invention.

FIG. 2 is a timing chart showing signal packets transmitted by means of isochronous format.

FIG. 3 is a block diagram showing a conventional optical repeater.

FIG. 4 is a block diagram showing a conventional optical transmission apparatus.

FIG. 5 is a block diagram showing a conventional apparatus which complies with IEEE 1394.

### DESCRIPTION OF PREFERRED EMBODIMENTS

Below, embodiments of the present invention are described in detail with reference to the attached drawings.

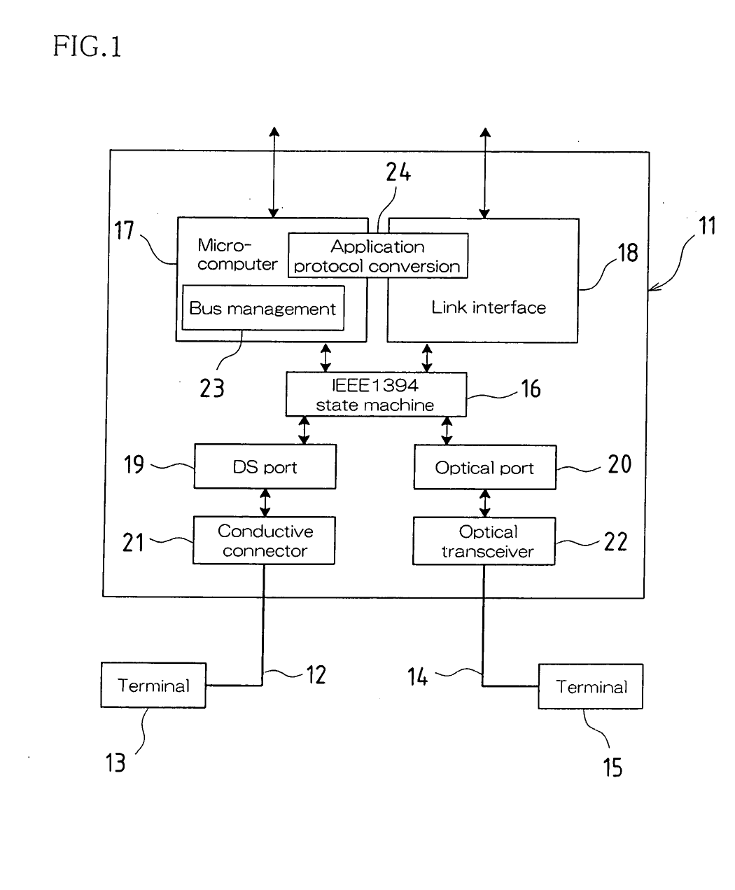

FIG. 1 is a block diagram showing an embodiment of the optical transmission apparatus of the present invention. Optical transmission apparatus 11 of the present embodiment complies with IEEE 1394, transmitting and/or receiving electrical signals to and/or from external terminal(s) 13 by way of conductive cable(s) 12, and/or transmitting and/or receiving optical signals to and/or from other external terminal(s) 15 by way of optical fiber(s) 14. At this optical transmission apparatus 11, microcomputer(s) 17 and link interface(s) 18 are connected in superior fashion with respect to IEEE-1394-compliant state machine(s) 16. Furthermore, DS port(s) 19 and optical port(s) 20 are connected in subordinate fashion with respect to state machine(s) 16; and moreover, conductive connector(s) 21 is or are connected to DS port(s) 19, and optical transceiver(s) 22 is or are connected to optical port(s) 20. Moreover, conductive cable(s) 12 is or are connected to conductive connector(s) 21, and optical fiber(s) 14 is or are connected to optical transceiver(s) 22, these functioning as bus(es) for respective transfer of various types of data.

State machine 16 has physical layer(s) which carry out signal transmission control, processing respective signals from microcomputer(s) 17 and link interface(s) 18 in superior relationship with respect thereto, processing respective signals from DS port(s) 19 and optical port(s) 20 in subordinate relationship with respect thereto, and acting as repeater(s) between superior and subordinate elements.

Microcomputer 17 has bus management functionality or functionalities 23 for managing bus(es) comprising conductive cable(s) 12 and optical fiber(s) 14. Such bus management functionality 23 might for example conform to PING or other such protocol which sets parameter(s) for determining bus arbitration time(s) based on actual measurement(s) of packet transmission time(s) over said bus(es). As a result of bus management by this bus management functionality 23, bus failure is made less likely to occur despite the fact that transmission delay(s) for data on bus(es) may exceed 144 ns.

Furthermore, microcomputer 17 and link interface 18 have application protocol conversion functionality 24. This application protocol conversion functionality 24 carries out mutual conversion between, say, DV-format signal transmission protocol(s) and MPEG-2TS-format signal transmission protocol(s), permitting mutual conversion between DV-format video data and MPEG-2TS-format video data.

DS port 19, being a port for transmitting and/or receiving DS signals, transmits and/or receives electrical signals by way of conductive connector(s) 21. DS port(s) 19 is or are connected to external terminal(s) 13 by way of conductive connector(s) 21 and conductive cable(s) 12, and DS port(s) 19, upon receiving electrical signal(s) from terminal(s) 13 by way of conductive cable(s) 12 and conductive connector(s) 21, convert such electrical signal(s) into signal(s) conforming to the specifications of state machine(s) 16 and output such converted signal(s) to state machine(s) 16, and/or convert signal(s) from state machine(s) 16 into electrical signal(s) conforming to the specifications of conductive connector(s) 21 and transmit such electrical signal(s) to terminal(s) 13 by way of conductive connector(s) 21 and conductive cable(s) 12. Furthermore, DS port(s) 19 detect presence and/or absence of terminal(s) connected to conductive cable(s) 12.

Optical port(s) 20, being port(s) for transmitting and/or receiving optical signal(s) as defined at IEEE 1394, are connected to other external terminal(s) 15 by way of optical transceiver(s) 22 and optical fiber(s) 14. Among the optical signals which may be sent and/or received by optical port(s) 20 are signals as defined, for example, at 4B5B, 8B10B, and so forth. Optical transceiver(s) 22, upon receiving optical signal(s) from terminal(s) 15 by way of optical fiber(s) 14, convert such optical signal(s) into electrical signal(s) and output such electrical signal(s) to optical port(s) 20. Optical port(s) 20 convert such electrical signal(s) into signal(s) conforming to the specifications of state machine(s) 16 and output such converted signal(s) to state machine(s) 16. Furthermore, optical port(s) 20, upon input thereto of signal(s) from state machine(s) 16, convert such signal(s) into signal(s) conforming to the specifications of optical transceiver(s) 22 and output such converted signal(s) to optical transceiver(s) 22. Optical transceiver(s) 22 convert such signal(s) into optical signal(s) and transmit such optical signal(s) to terminal(s) 15 by way of optical fiber(s) 14. Moreover, optical port(s) 20 detect presence and/or absence of terminal(s) connected to optical fiber(s) 14.

Terminal 13 displays, at screen(s), video represented by video data conforming to MPEG-2TS-format signal transmission protocol(s), transmitting and/or receiving MPEG-2TS-format video data as electrical signal(s) to/from optical transmission apparatus(es) 11 by way of conductive cable(s) 12 in accordance with IEEE 1394.

Terminal 15 displays, at screen(s), video represented by video data conforming to DV-format signal transmission protocol(s), carrying out mutual conversion between optical signal(s) and signal(s) representing DV-format video data, and moreover, transmitting and/or receiving such optical signal(s) to/from optical transmission apparatus(es) 11 by way of optical fiber(s) 14 in accordance with IEEE 1394.

In such a constitution, terminal(s) 15 may, for example, transmit optical signal(s) representing video data conforming to DV-format signal transmission protocol(s) to optical transmission apparatus(es) 11 by way of optical fiber(s) 14. At optical transmission apparatus(es) 11, such optical signal(s) may be converted into electrical signal(s) by optical transceiver(s) 22, such electrical signal(s) may be converted into signal(s) conforming to specifications of state machine(s) 16, and such converted signal(s) may be output to state machine(s) 16. State machine(s) 16 may provide such signal(s), i.e., signal(s) representing video data conforming to DV-format signal transmission protocol(s), to application protocol conversion functionality or functionalities 24 of microcomputer(s) 17 and link interface(s) 18, and at the same time, output said signal(s) to DS port(s) 19.

Application protocol conversion functionality or functionalities 24 may convert signal(s) representing video data in accordance with DV-format signal transmission protocol(s) into signal(s) representing MPEG-2TS-format video data, and may output such converted signal(s) to DS port(s) 19.

Accordingly, DS port(s) 19 may more or less simultaneously receive input of signal(s) representing video data in accordance with DV-format signal transmission protocol(s) and signal(s) representing MPEG-2TS-format video data. Moreover, DS port(s) 19 may transmit both signals or sets of signals to external terminal(s) 13 by way of conductive connector(s) 21 and conductive cable(s) 12.

At such time, bus management functionality or functionalities 23 of microcomputer(s) 17 manage bus(es) comprising optical fiber(s) 14 and conductive cable(s) 12 in conformance with IEEE 1394, permitting transmission of video data to be carried out quickly and proactively preventing bus failure.

Here, signal(s) representing DV-format video data and signal(s) representing MPEG-2TS-format video data are transmitted in accordance with isochronous format(s) as defined at IEEE 1394. In accordance with such isochronous format, data is divided into appropriate width(s), data blocks produced as a result of such division are assigned to respective packets, and packets are transmitted and/or received by way of bus(es); and because packet transmission rate is set sufficiently higher than transmission rate(s) of signal(s) representing DV-format video data and/or signal(s) representing MPEG-2TS-format video data, DV-format signal(s) and MPEG-2TS-format signal(s) can be transmitted and or received more or less simultaneously through time division.

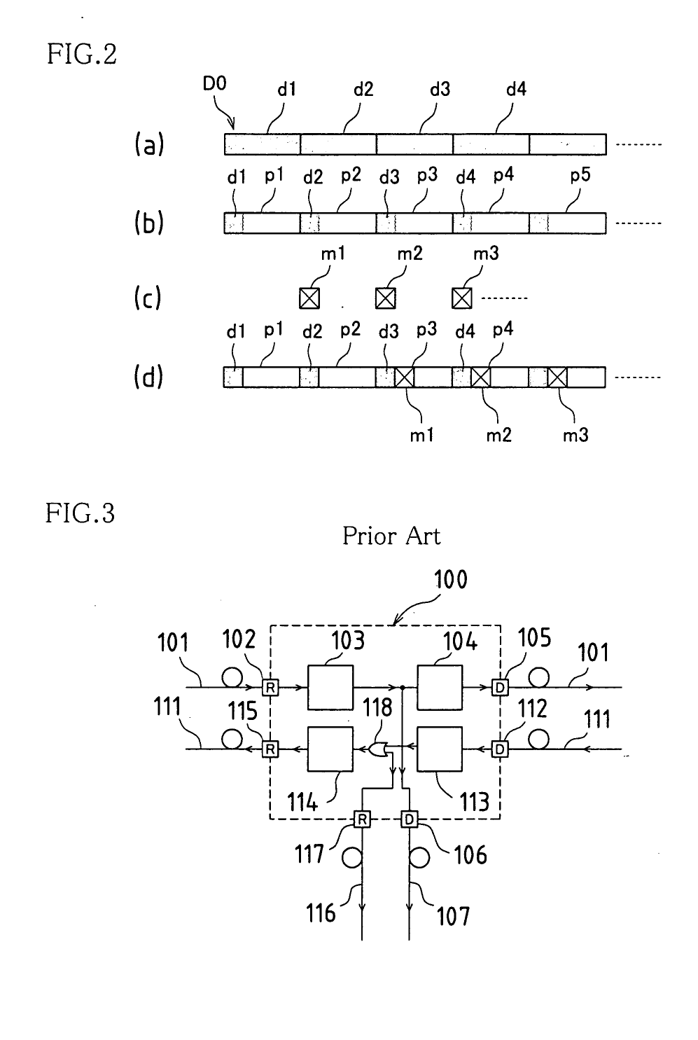

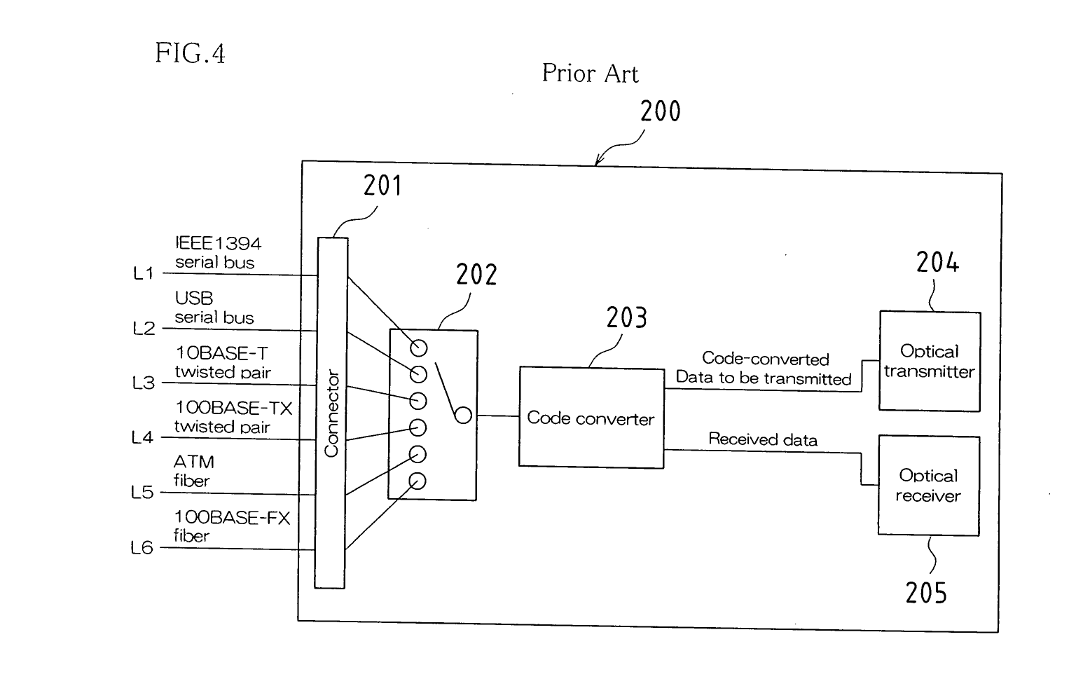

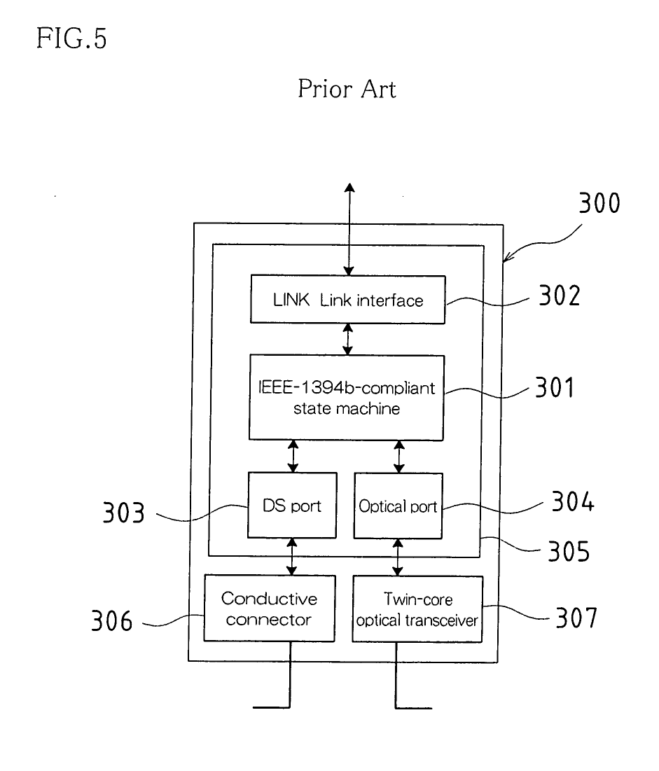

FIG. 2 is a timing chart showing signal packets transmitted by means of isochronous format. At terminal 15, for example, signal DO representing DV-format video data might be divided into signals d1, d2, d3, . . . as shown at FIG. 2 (a); signals d1, d2, d3 . . . might be assigned to respective packets p1, p2, p3, . . . as shown at FIG. 2 (b); and these packets p1, p2, p3, . . . might be transmitted as optical signal(s) to optical transmission apparatus 11 by way of optical fiber 14. At such time, packets p1, p2, p3, . . . would have sufficient room for other signals. On the other hand, at optical transmission apparatus 11, signals d1, d2, d3, . . . might be extracted from packets p1, p2, p3, . . . forming signal DO representing DV-format video data; signal DO representing DV-format video data might be converted into signal(s) representing MPEG-2TS-format video data; MPEG-2TS-format signal(s) might be divided into signals m1, m2, m3, . . . as shown at FIG. 2 (c); and signals m1, m2, m3, . . . might be assigned to respective packets p3, p4, p5, . . . as shown at FIG. 2 (d). At such time, DV-format signals d1, d2, d3, . . . and MPEG-2TS-format signals m1, m2, m3, . . . would be assigned as appropriate to packets p1, p2, p3, . . . . In addition, packets p1, p2, p3, . . . at FIG. 2 (d) might be transmitted as electrical signal(s) from optical transmission apparatus 11 to terminal 13 by way of conductive cable 12.

Note that instead of transmitting video data from terminal(s) 15 to terminal(s) 13 by way of optical transmission apparatus(es) 11, it is also possible to transmit video data from terminal(s) 13 to terminal(s) 15 by way of optical transmission apparatus(es) 11. In such case, MPEG-2TS-format video data would be divided up and assigned to packets, these packets would be transmitted as electrical signal(s) from terminal(s) 13 to optical transmission apparatus(es) 11, MPEG-2TS-format video data would be converted to DV-format video data at optical transmission apparatus(es) 11, DV-format video data would be divided up and assigned to packets, and packets to which MPEG-2TS-format video data and DV-format video data have been assigned would be transmitted as optical signal(s) from optical transmission apparatus(es) 11 to terminal(s) 15 by way of optical fiber(s) 14.

Furthermore, optical signal(s) may be transmitted by way of optical fiber(s) not only between or among terminal(s) 15 and optical transmission apparatus(es) 11 but also between or among terminal(s) 13 and optical transmission apparatus(es) 11. Furthermore, electrical signal(s) may be transmitted by way of conductive cable(s) not only between or among terminal(s) 13 and optical transmission apparatus(es) 11 but also between or among terminal(s) 15 and optical transmission apparatus(es) 11.

Furthermore, the present embodiment is not limited to conversion between DV-format signal transmission protocol(s) and MPEG-2TS-format signal transmission protocol(s), there being no objection to carrying out conversion between any other two varieties of formats. For example, application protocol conversion functionality or functionalities 24 may carry out conversion between or among 1-bit audio signal transmission protocol(s) and multi-bit audio signal transmission protocol(s). In such case, 1-bit audio signal(s) would be transmitted from terminal(s) 15 to optical transmission apparatus(es) 11, such 1-bit audio signal(s) would be converted to multi-bit audio signal(s), and 1-bit audio signal(s) and multi-bit audio signal(s) would be transmitted from optical transmission apparatus(es) 11 to terminal(s) 13. Multi-bit audio signal transmission protocol(s) may be substantially as defined at IEC 60958 and/or MPEG Audio Layer-3.

Moreover, at optical transmission apparatus 11, when either DV-format video data or MPEG-2TS-format video data is received, conversion may be carried out between said formats and video data formatted according to each of the formats may be transmitted; and in addition, when either 1-bit audio signal(s) or multi-bit audio signal(s) is received, conversion may be carried out between said formats and audio data formatted according to each of the formats may be transmitted. That is, there is no objection to carrying out conversion of video data together with conversion of audio data and so forth.

Furthermore, there is no objection to having application protocol conversion functionality or functionalities 24 take the form of removable module(s) at microcomputer(s) 17 and link interface(s) 18. In such a case, user(s) might be allowed to select whether module(s) containing application protocol conversion functionality or functionalities 24 should be installed at optical transmission apparatus(es) 11, permitting reduction in the basic cost of optical transmission apparatus 11. Furthermore, in the event that new video and/or audio transmission formats come into existence, all that would be required would be to replace the module(s), permitting reduction in cost. For example, methods for compressing video and/or audio developed in-house by manufacturers, MPEG-4, and the like currently make use of storage file(s), use of transmission format(s) being unusual. However, in the future, such compression methods may well make use of transmission formats. A plurality of modules respectively accommodating conversions between respective sets of two formats could be provided, selection of such modules by users making it possible to easily and flexibly deal with future transmission formats.

Moreover, there is no objection to employment of microcomputer(s) comprising link interface(s) instead of providing microcomputer 17 and link interface 18 as separate units.

Furthermore, miniaturization of optical connector(s) for optical transceiver(s) 22 and conductive connector(s) 21 may be done in conformance with supplemental IEEE 1394 specifications.

Moreover, optical transmission apparatus(es) 11 may be built into terminal 13 and/or terminal(s) 15. Examples of terminals include various types of video equipment, audio equipment, personal computers, and so forth.

The present invention may be embodied in a wide variety of forms other than those presented herein without departing from the spirit or essential characteristics thereof. The foregoing embodiments and working examples, therefore, are in all respects merely illustrative and are not to be construed in limiting fashion. The scope of the present invention being as indicated by the claims, it is not to be constrained in any way whatsoever by the body of the specification. All modifications and changes within the range of equivalents of the claims are moreover within the scope of the present invention.

Moreover, the present application claims right of benefit of prior filing date of Japanese Patent Application No. 2003-192064, the content of which is incorporated herein by reference in its entirety. Furthermore, all references cited in the present specification are specifically incorporated herein by reference in their entirety.

1. An optical transmission apparatus, comprising:
a plurality of ports for transmitting and/or receiving one or more signals substantially as defined at IEEE 1394;
at least one of the ports being for transmitting and/or receiving one or more optical signals; and
one or more protocol conversion means for carrying out signal transmission protocol conversion at a physical-layer level on at least one of the optical signals transmitted and/or received by said at least one of the ports;
wherein one or more bus management means co-manages one or more signal buses which are respectively connected externally to at least a portion of the plurality of ports.

2. The optical transmission apparatus according to claim 1, wherein
said one or more protocol conversion means carries out signal transmission protocol conversion at an application level.

3. The optical transmission apparatus according to claim 2 wherein
at least one of the application-level protocol conversion means carries out conversion between or among one or more DV-format signal transmission protocols and one or more MPEG-2TS-format signal transmission protocols.

4. The optical transmission apparatus according to claim 2 wherein
at least one of the application-level protocol conversion means carries out conversion between or among one or more 1-bit audio signal transmission protocols and one or more multi-bit audio signal transmission protocols.

5. The optical transmission apparatus according to claim 4 wherein
at least one of the multi-bit audio signal transmission protocol or protocols is substantially as defined at IEC 60958.

6. The optical transmission apparatus according to claim 4 wherein
at least one of the multi-bit audio signal transmission protocol or protocols is substantially as defined at MPEG Audio Layer-3.

7. The optical transmission apparatus according to claim 2 wherein
one or more of the application-level protocol conversion means take the form of one or more replaceable modules.

8. Electronic equipment comprising one or more optical transmission apparatuses according to any of claims 1 through 7.
